(19) United States
(12) Patent Application Publication
(10) Pub. No.: US 2006/0143963 A1
(43) Pub. Date: Jul. 6, 2006

(54) Bottle neckhanger

(75) Inventor: Anthony J. Nowakowski, Crystal Lake, IL (US)

Correspondence Address: GREER, BURNS & CRAIN, 300 S WACKER DR, 25TH FLOOR, CHICAGO, IL, 60606, US

(73) Assignee: Carol Joyce Witt

(21) Appl. No.: 11/027,970

(22) Filed: Jan. 3, 2005

(51) Int. Cl. G09F 3/10; G09F 3/00

(52) U.S. Cl. 40/673; 40/310

(57) ABSTRACT

A neckhanger for displaying promotional items on a container includes a sheet of material defining an aperture. In addition, the aperture has at least one straight edge constructed and arranged for engaging a lip of the container before a remainder of the aperture engages the container.

### BACKGROUND

The present invention generally relates to promotional items automatically attachable to beverage containers or similar packages, and more particularly, to neckhangers intended for use on beverage containers such as bottles. In the present application, “neckhanger” will relate to a promotional item such as a coupon, a giveaway or premium, or the like configured to hang from the neck of a bottle or similar beverage containers.

Until present, placing neckhanger promotional items (or premiums) on containers had to be performed manually at the store level, or automatically with the use of a staging device. However, automatic application has not been found to be efficient. Some existing applicators require the container receiving the neckhanger to be stationary for placement over the neck, while others are applicable continuously, but achieve only limited success and/or efficiency. One problem with conventional neckhangers is that they do not positively engage the neck of the bottle. Also, when conventional neckhangers engage the container, they often curl upward and are insufficiently secured to the container, requiring a person to subsequently manually secure the neckhanger.

Modifying the aperture design of conventional neckhangers has been attempted, however, there has been a general failure to improve the actual placement of the neckhanger on the container. One attempted solution has been the addition of fingers to allow the aperture used to engage the container to expand in size to clear certain features of the container, and for retention after application. These features, such as fingers, are disclosed in U.S. Pat. Nos. 3,797,658 and 5,826,356. In both references, a neckhanger coupon designed for attachment onto a beverage container is disclosed, where the neckhanger has an opening with slits used for retention on the container after the neckhanger has cleared the lip of the container. Other modifications include varying the shape of the opening, such as using an ellipse rather than the conventional circle.

Another variation on the structure of a neckhanger aperture is disclosed in U.S. Pat. No. 4,208,819, which discloses an aperture with a discontinuous straight edge used for retention after application. The container is engaged by a round edge of the neckhanger, and then the neckhanger is secured to the container by pressing down on the neckhanger so that the discontinuous straight edge is underneath the container lip. Since the neckhanger has a discontinuous straight edge, the two separate straight edges deform as the neckhanger is pressed down onto the container and secured underneath the lip. This results in the discontinuous straight edge acting like slits or fingers for retention after engagement and not as a structure for engaging the container first in an automated application system. The '819 patent, therefore, suffers from the same problems and drawbacks described above. Indeed, none of the known aperture modifications relate to improving the automatic and continuous application of neckhangers onto the containers.

Therefore, there is a need for an improved neckhanger that is capable of positively engaging a container in a more efficient, automated and continuous manner.

In addition, there is a need for an improved automated method for more positively engaging a neckhanger onto a container.

### SUMMARY OF THE INVENTION

The above-listed needs are met or exceeded by the present improved neckhanger which is configured for being automatically and continuously applied to a container. The present neckhanger features improved geometry of the aperture used to engage the container for contacting more of the container's surface and for allowing greater attachment success. In addition, automatic and continuous application is achievable by staging the neckhanger in a position over a production line so that a passing container snags the present neckhanger and pulls it from the staging device.

More specifically, a neckhanger is provided for displaying promotional items on a container and includes a sheet of flexible material defining an aperture. The aperture has at least one straight edge constructed and arranged for engaging a lip of the container before a remainder of the aperture engages the container.

In another embodiment, a method for automatically applying a neckhanger onto containers includes suspending the neckhanger having an aperture from a staging device where the aperture has at least one straight edge. Next, the container is advanced towards the neckhanger until a lip on the container engages the at least one straight edge of the aperture. Subsequent movement of the container toward the neckhanger causes the neckhanger to be released from the staging device and engaged upon the container.

### BRIEF DESCRIPTION OF THE DRAWINGS

FIG. 1 is an overhead plan view of a prior art neckhanger;

FIG. 2 is a schematic front view of a prior art neckhanger engaging a container;

FIG. 3 is a schematic side view of the present neckhanger about to engage a container;

FIG. 4 is an overhead plan view of the present neckhanger;

FIG. 5 is a schematic front view of the present neckhanger shown engaging a container;

FIG. 6 is a schematic side view of a container that illustrates the minimum diameter of an aperture of the present neckhanger;

FIG. 7 is a fragmentary overhead plan view of the present neckhanger engaging the container;

FIG. 8 is a fragmentary overhead plan view of a second embodiment of the present neckhanger shown engaging a container;

FIG. 9 is a fragmentary overhead plan view of a third embodiment of the present neckhanger shown engaging a container;

FIG. 10(a) is a fragmentary front view of one type of neck and lip of a container suitable for use with the present neckhanger;

FIG. 10(b) is a fragmentary front view of a second type of neck and lip of a container suitable for use with the present neckhanger; and

FIG. 10(c) is a fragmentary front view of a third type of neck and lip of a container suitable for use with the present neckhanger.

### DETAILED DESCRIPTION

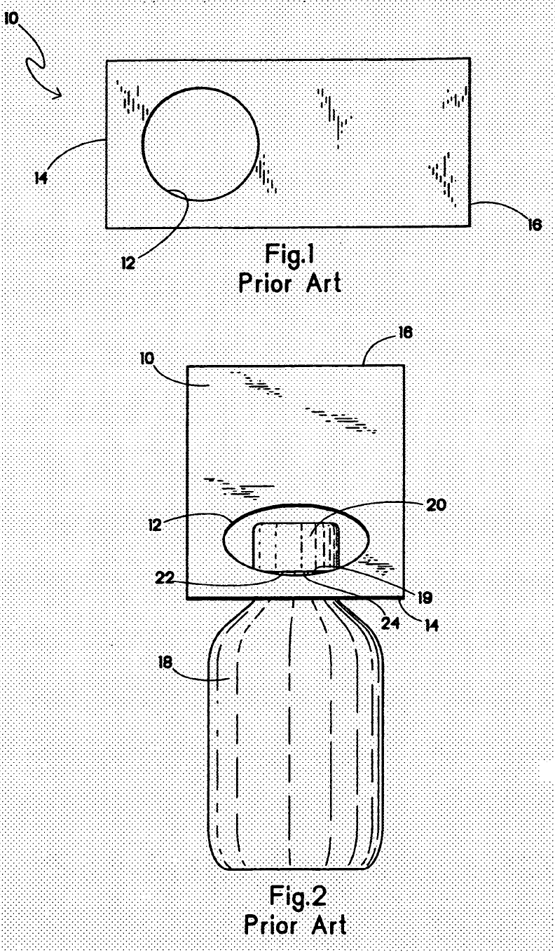

Referring now to FIG. 1, a conventional neckhanger is generally designated 10. The neckhanger 10 is generally planar and typically rectangular in shape, however, other shapes are contemplated. As is known in the art, such neckhangers 10 are made of heavy paper, cardboard, plastic or similar inexpensive sheet material that can withstand automatic handling. A circular aperture 12 is disposed closer to one end 14 of the neckhanger 10, an opposite end 16 is typically used as a surface to which are attached promotional materials such as coupons, small packages of food, novelty items or the like.

Now referring to FIG. 2, a container 18 such as a beverage or food bottle or a similar container has a relatively narrow neck 19. In addition, the container 18 has a cap 20 radially extending from the neck 19, having a lip 22 formed at a bottom edge 24 of the cap and is dimensioned to form a radially extending shoulder relative to the container 18. The aperture 12 of the neckhanger 10 engages the lip 22. One disadvantage of the prior neckhanger 10 is that when the neckhanger's circular aperture 12 engages the lip 22, the neckhanger end 16 often folds, causing side edges of the aperture to curl upwards away from the lip, thereby reducing the amount of material in contact with the lip. As a result, the neckhanger 10 does not properly engage the lip 22 and, thus, disengages from the container 18 and remains attached to an automatic staging device (not shown). It has been found that neckhangers 10 having a substantially circular aperture 12, such as depicted in FIG. 1, have reduced the efficiency of conventional continuous automated neckhanger application systems.

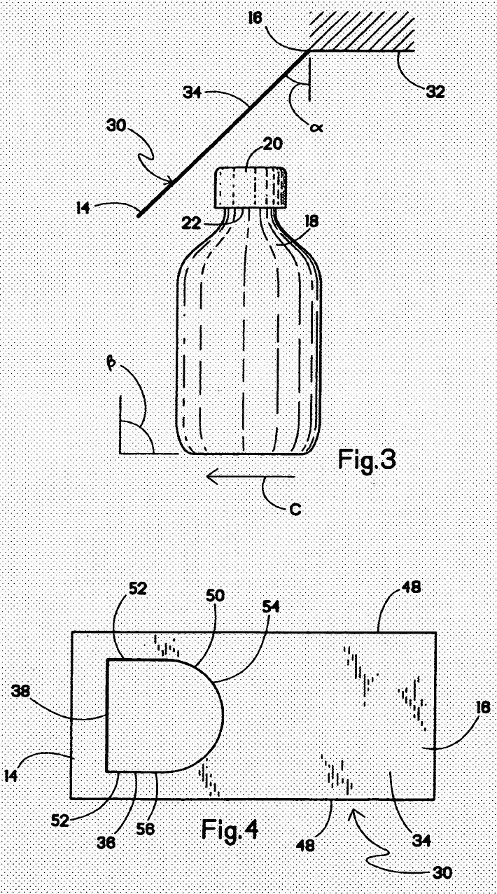

Referring now to FIG. 3, an improved neckhanger is generally designated 30. Components shared with the neckhanger 10 are designated with like reference numerals. As is known in the art, the neckhanger 30 is positioned relative to a moving bottle conveyor line represented by the arrow ‘C’ by an automatic staging or feeding mechanism, schematically represented at 32. Such feeding mechanisms are well known in the art. A neckhanger 30 is removed from a web or roll of such hangers and is positioned by the mechanism 32 for engagement upon a container 18. As the conveyor C moves the containers 18 toward the neckhanger 30, the neckhanger becomes positively engaged on the next container. Further movement of the conveyor C causes the container 18 to make room for the next container in line and for the application of another neckhanger 30. In addition, the neckhanger 30 is constructed from a sheet of material 34 which is similar to that used in the neckhanger 10.

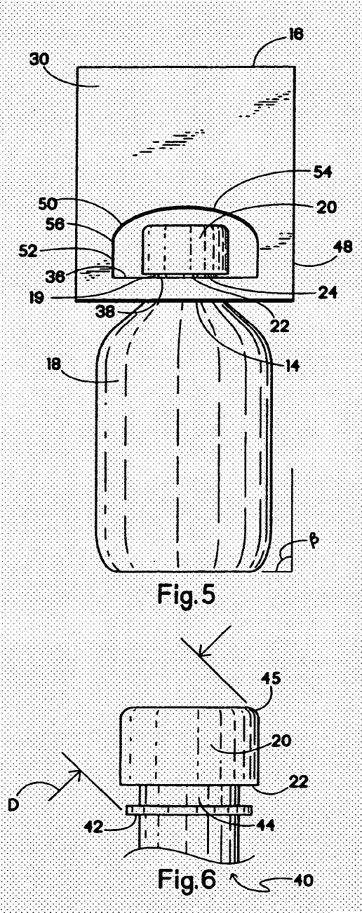

Referring now to FIGS. 4 and 5, a main distinguishing feature of the neckhanger 30 is the configuration of an aperture 36. More specifically, the aperture 36 has at least one straight edge 38 constructed and arranged for engaging the lip 22 of the container cap 20 (best seen in FIG. 5). This engagement occurs as the conveyor C moves the containers B into operational position (FIG. 3). Referring now to FIGS. 3 and 5, the straight edge 38 of the aperture 36 engages the lip 22 at an angle β that is generally perpendicular to the direction of travel of the container 18 is traveling on the conveyor C. In addition, the neckhanger 30 as a whole engages the container 18 at an approximate angle α of approximately 45 degrees (best seen in FIG. 3). It is contemplated that, while these angular orientations are preferred, variations may occur to suit particular applications.

Now referring to FIG. 6, in another embodiment, the neckhanger 30 can also be attached to a container 40 by engaging the underside of an annular, radially extending ridge 42. Components that are common to both containers 18, 40 are designated with like reference numerals.

As before, the straight edge 38 engages the annular, ridge 42 in the same manner as it engages the lip 22. One main difference is that a neck portion 44 separates the annular ridge 42 and the cap 20. For the neckhanger 30 to be properly secured to the container 40, the aperture 36 preferably has a diameter greater than a diagonal distance ‘D’ measured from a top 45 of the cap 20 on the container to an underside of the annular ridge 42. This allows a remaining portion of the neckhanger 30 to clear the cap 20 and be secured underneath the annular ridge 42 after the straight edge 38 has engaged the annular ridge. Similarly, although not shown in FIG. 6, when the neckhanger 30 engages the lip 22 of the container 18, instead of the annular ridge 42, the aperture 36 preferably has a diameter greater than a diagonal distance measured from the top 45 of the cap 20 on the container 18 to an underside of the lip. In addition, the length of the straight edge 38 is generally equal to or slightly greater than, the diameter of the aperture 36 so that the neckhanger 30 can clear the cap 20 and/or the annular ridge 42 during automatic application.

Referring back to FIG. 4, the sheet 34 is generally rectangular with two relatively short ends 14, 16 and two relatively long sides 48. Additionally, the aperture 36 is closer to the end 14. Furthermore, the straight edge 38 of the aperture 36 is closer to the end 14′ than a remainder 50 of the aperture. As seen in FIG. 5, if this configuration were reversed (i.e. the remainder 50 of the aperture 36 were closer to the end 14), then the straight edge 38 would not engage the lip 22 and the present neckhanger 30 would suffer from the same problems as prior art neckhangers discussed above.

In addition to the straight edge 38, the aperture 36 also includes a pair of spaced, generally parallel edges 52 each intersecting the straight edge. Furthermore, the aperture 36 includes a radius edge 54 joining ends 56 of the parallel edges 52 opposite the straight edge to form a “D” shape. An angle that is created between each of the parallel edges 52 and the straight edge 38 is approximately 90 degrees.

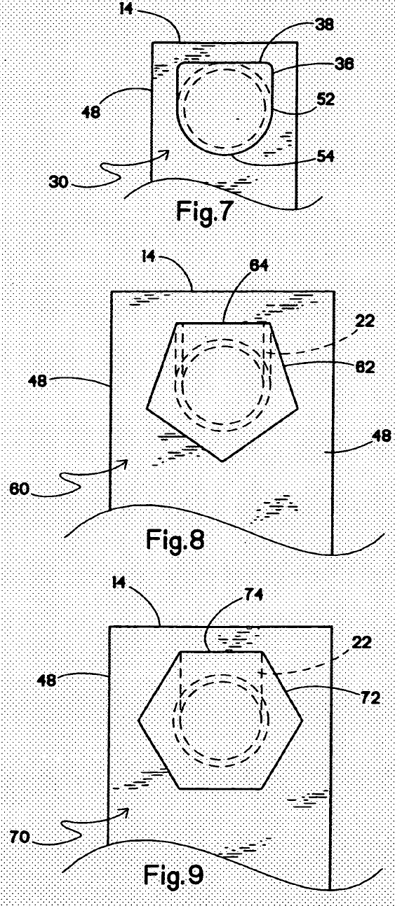

Referring now to FIG. 7, the preferred embodiment of the invention is a neckhanger 30 in which the aperture 36 is generally “D”-shaped. The “D”-shaped aperture 36 has a straight edge 38 for properly engaging the lip 22 (shown in dashed lines). Referring now to FIG. 8, a second embodiment discloses a neckhanger generally designated 60 with a generally pentagonally-shaped aperture 62 having a straight edge 64 for engaging the lip 22 (shown in dashed lines). As seen in FIG. 9, in a third embodiment a neckhanger generally designated 70 having a generally hexagonally-shaped aperture 72 is also contemplated, which includes a straight edge 74 for engaging the lip 22 (shown in dashed lines). In all three embodiments 30, 60, 70 commonly shared components are designated with life reference numbers, and all three share a common characteristic: a straight edge (38, 64, 74) located closer to the respective short end 14 than a remainder of the aperture 36, 62, 72 for engaging the lip 22, which increases the efficiency of the continuous automated neckhanger application system.

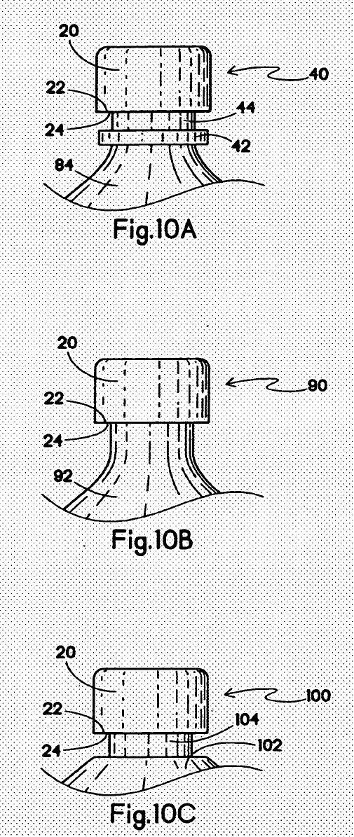

Referring now to FIGS. 10(a)-(c), components shared by three alternate containers and the previously described containers 18, 40 are designated with like reference numerals. In 10(a), the straight edges 38, 64, 74 of the neckhangers 30, 60, 70 can engage either the lip 22, or the annular ridge 42 on the container 40. To ensure proper engagement, the upper neck portion 44 and a lower neck portion 84 both have smaller diameters than the lip 22 and the annular ridge 42, respectively, so that the neckhanger 30, 60, 70 is properly secured underneath the lip or annular ridge. In FIG. 10(b), a container 90 only has the lip 22, on the 20, for engagement by the straight edges 38, 64, 74. The container 90 has a neck 92 with a smaller diameter than the cap 20 so that the neckhanger 30, 60, 70 can be properly engaged upon the container.

Referring now to FIG. 10(c), a container 100 has a preferably tapered lower neck 102 and its smallest diameter is approximately equal to the diameter of the cap 20. However, the neckhanger 30, 60, 70 can still be secured to the container 100 because an upper neck portion 104 has a diameter smaller than that of the cap 20. When looking at FIGS. 10(a)-(c), it is evident that the necks 44, 92, 104 of the containers 80, 90, 100 all have a diameter smaller than the cap 20 or the annular ridge 42 so that the neckhanger 30, 60, 70 is secured underneath the lip or annular ridge. When the neckhanger 30, 60, 70 is about to engage the container 40 such as the one in FIG. 10(a) that has both a lip 22 and annular ridge 42, it possible to configure the application system so that the neckhanger engages either the lip 22 or the annular ridge 42.

A method for automatically applying the neckhanger 30 onto containers 18 will now be described. However, it is contemplated that the method is suitable for use with any of the above-described embodiments. Referring now to FIGS. 3 and 4, the first step includes suspending the neckhanger 30 having the aperture 36 having at least one straight edge 38 from the staging device 32. The second step includes advancing the container 18 on the conveyor C toward the neckhanger 30 until the lip 22 on the container 18 engages the straight edge 38 of the aperture 36, whereby subsequent movement of the container 18 toward the neckhanger causes the neckhanger to be released or separated from the staging device 32 and engaged upon the container 18. The straight edge 38 prevents the neckhanger 30 from curling and flexing once the straight edge engages the container 18.

Thus, the neckhanger 30 remains stable and is properly detached from the staging device 32 and engaged upon the container 18, which results in an efficient continuous automated process for placing neckhangers 30 onto containers 18. When the present method is implemented using both of the preferred angles, the continuous automated process for placing neckhangers 30 onto containers 18, is improved over prior art neckhangers.

While particular embodiments of the present neckhanger for placement onto containers have been described herein, it will be appreciated by those skilled in the art that changes and modifications may be made thereto without departing from the invention in its broader aspects and as set forth in the following claims.

What is claimed is:

1. A neckhanger for displaying promotional items on a container, comprising:
a sheet of material defining an aperture;
said aperture has at least one straight edge constructed and arranged for engaging a lip of the container before a remainder of said aperture engages the container.

2. The neckhanger of claim 1, wherein said aperture has a diameter greater than a diagonal distance measured from a top of a cap on the container to an underside of the lip.

3. The neckhanger of claim 2, wherein a length of said straight edge is generally equal to said diameter.

4. The neckhanger of claim 1, wherein said sheet is generally rectangular with two relatively short ends and two long sides; and wherein said aperture is closer to one of said ends than to the other.

5. The neckhanger of claim 4, wherein said straight edge is closer to said corresponding end than said remainder of said aperture.

6. The neckhanger of claim 5, wherein said aperture has a pair of spaced, generally parallel edges each intersecting said straight edge.

7. The neckhanger of claim 6, further including a radius edge joining ends of said parallel edges opposite said straight edge.

8. The neckhanger of claim 6, wherein an angle defined between each of said parallel edges and said straight edge is approximately 90 degrees.

9. The neckhanger of claim 1, wherein said aperture is defined by said neckhanger as being one of generally “D”-shaped, generally pentagonally-shaped, and generally hexagonally-shaped.

10. A method for automatically applying a neckhanger onto containers, comprising the steps of:
suspending a neckhanger having an aperture from a staging device wherein the aperture has at least one straight edge; and
advancing a container toward the neckhanger until a lip on the container engages the straight edge of the aperture, whereby subsequent movement of the container toward the neckhanger causes the neckhanger to be released from the staging device and engaged upon the container.

11. The method of claim 10 wherein the straight edge of the aperture engages the lip at an angle generally perpendicular to a direction the container is traveling.

12. The method of claim 10 wherein the neckhanger engages the container at an approximate angle of 45 degrees.

13. A neckhanger for use in automatically applying promotional items onto containers, comprising:
a sheet of flexible material having straight edge means for engaging a container.

14. The neckhanger of claim 13 wherein said straight edge means has a diameter greater than a diagonal distance measured from a top of a cap on the container to an underside of a lip on the container.

15. The neckhanger of claim 14 wherein the lip is either one of a bottom of a cap and an annular ridge.

16. The neckhanger of claim 13 wherein said straight edge means is an aperture defined as one of generally “D”-shaped, generally hexagonally shaped, and generally pentagonally shaped.

17. The neckhanger of claim 13 wherein said sheet is generally rectangular with two short sides and two long sides; and wherein said straight edge means is closer to one to an end of the aperture than a remainder of said aperture.

18. The neckhanger of claim 17 further wherein said aperture has a pair of spaced generally parallel edges each intersecting said straight edge means.

19. The neckhanger of claim 18, wherein said aperture further includes a radius edge joining ends of said parallel edges opposite said straight edge means; and wherein an angle between said parallel edges and said straight edge means is generally 90 degrees and wherein said straight edge means is closer to said end than a remainder of said aperture.
